(19) United States
(12) Patent Application Publication
(10) Pub. No.: US 2014/0016923 A1
(43) Pub. Date: Jan. 16, 2014

(54) MULTILAYER COMMUNICATIONS NETWORK SYSTEM FOR DISTRIBUTING MULTICAST SERVICES AND A METHOD FOR SUCH A DISTRIBUTION

(71) Applicants: Juan Fernández-Palacios, Madrid (ES); Oscar González, Madrid (ES); Javier Jiménez, Madrid (ES)

(72) Inventors: Juan Fernández-Palacios, Madrid (ES); Oscar González, Madrid (ES); Javier Jiménez, Madrid (ES)

(73) Assignee: TELEFONICA, S.A., Madrid (SE)

(21) Appl. No.: 13/979,399

(22) PCT Filed: Dec. 27, 2011
(86) PCT No.: PCT/EP2011/074081

§ 371 Date: Sep. 30, 2013

(30) Foreign Application Priority Data
Jan. 13, 2011 (ES) P201130032

(51) Int. Cl. H04B 10/038; H04Q 11/00

(52) U.S. Cl. CPC H04B 10/038; H04Q 11/0071
USPC 398/2

(57) ABSTRACT

A multilayer communications network system for distributing multicast services and a method for such a distribution The system comprises a switched optical transport network layer, such as a WSON, and an electronic packet switched network layer, such as a IP/MPLS, where the switched optical transport network layer transports multicast flows services and the electronic packet switched network layer is a backup layer of a dynamic restoration mechanism for recovery against one or more failures occurring in the switched optical transport network layer. The method comprises transporting multicast flows services through the switched optical transport network layer, and performing a recovery against one or more failures occurring in the switched optical transport network layer by means of a dynamic restoring carried out by using said electronic packet switched network layer as a backup layer.

### FIELD OF THE ART

The present invention generally relates, in a first aspect, to a multilayer communications network system for distributing multicast services, combining a switched optical transport network layer, such as a WSON, and an electronic packet switched network layer, such as an IP/MPLS, and more particularly to a system where the electronic network is used for restoring connections lost due to failures in the optical network.

A second aspect of the invention relates to a method for distributing multicast services through a multilayer communications network system, which can be implemented by the system of the first aspect.

The invention provides a new restoration scheme for high capacity multicast services (e.g. HD-TV and UHDTV) over long-haul networks.

### PRIOR STATE OF THE ART

### Existing Resilience Technologies for P2MP Connections Over Optical Switching Networks:

Wavelength division multiplexing (WDM) is one technology that is envisioned to increase bandwidth capability and enable bidirectional communications in optical networks. In WDM networks, multiple data signals can be transmitted simultaneously between network elements (NEs) using a single fibre. Specifically, the individual signals may be assigned different transmission wavelengths so that they do not interfere or collide with each other. The path that the signal takes through the network is referred to as the lightpath. One type of WDM network, a wavelength switched optical network (WSON) [6], seeks to switch the optical signals by means of ROADM (Reconfigurable Optical Add Drop Multiplexer) without optical-electrical-optical (OEO) conversions. ROADMs are asymmetric wavelength selective switching elements featuring ingress and egress line side ports as well as add/drop side ports.

ROADMs with drop & continue capability can provide one-to-many fan-out of a channel for optical multicasting so that a single optical channel (lambda) could be used for a point to multipoint (P2MP) connection. FIG. 1 shows an example of optical multicasting where a single channel (ITV) is used for IPTV distribution from the Head end to multiple metropolitan nodes, where module 1.2.1 converts the IP-TV digital stream into an optical signal while module 1.2.2 converts the optical signal generated by 1.2.1 into a digital IP-TV stream.

Currently, there already exist technical alternatives for optical multicasting over WSON, such a those incorporating multicast resilience mechanisms for optical switching networks, as is the case of the disclosures of U.S. Pat. No. 7,366,417, which describes delivering multicast services on a wavelength division multiplexed network using a configurable four-port wavelength selective crossbar switch, and U.S. Pat. No. 6,850,707 referring to a secure optical layer multicasting to effect survivability.

Said technical alternatives, or current solutions, are based on two different approaches: protection and restoration.

As far as protection is concerned, it consists in pre-calculating a working multicast tree and a backup multicast tree, both according to shortest path algorithm. There is another condition to compute the backup tree: it must be link-disjointed respect to the working one (FIG. 2).

At the initial situation, a pre-calculated working multicast tree is established (FIG. 2a). After a multiple link failure event, if there is an error affecting any link of the primary multicast tree, the resilience mechanism switches to the pre-calculated backup multicast tree, if possible (FIG. 2b). In this situation, if a link failure affects any link of the backup multicast tree, the resilience mechanism tries to re-establish the pre-computed working multicast tree (FIG. 2a).

As far as restoration is concerned, as soon as the network starts to work, a multicast tree is computed and established according to a given algorithm. After a multiple link failure event, if there is an error affecting any link of the established multicast tree, the resilience mechanism searches another possible multicast tree according to the available network resources, avoiding the broken links. In this manner, it is tried to maintain the multicast tree in all the access nodes.

Protection mechanisms are not able to restore multiple simultaneous link failures and consume dedicated WSON back up resources that cannot be used for other purposes. Furthermore, it requires completely disjoint working and backup multicasting trees and this might not be possible in some WSON networks.

Above problems might be solved by using dynamic restoration schemes. However, restoration mechanisms present another problem: recovery speed in WSON is very slow since the establishment of a new channel over the WSON requires some network reconfigurations (power channels equalization, filters tuning, etc.) which could take seconds or even minutes.

### Existing Resilience Technologies for P2MP Connections Over Electronic Switching Networks:

FIG. 3 shows the typical electronic packet based core network (e.g. IP/MPLS) of a telecom operator providing Internet services to end customers.

In this structure, the traffic (the data) is routed thanks to inter-domain routing protocols and other techniques to make the switching more efficient (such as MPLS [15]): traffic coming from the edges of the IP network (interconnection or access nodes) crosses the IP network through the transit nodes to reach the other edges (interconnection or access nodes).

As described in [16], IP/MPLS networks are able to support and restore multicast connections.

Some multicast resilience mechanisms for packet electronic switching networks are described in next patent documents: U.S. Pat. No. 7,251,214, regarding a system and method for providing protection of data communications in packet-based networks, U.S. Pat. No. 7,675,870 related to a IP-TV broadcasting service system and method using physical layer's multicast switch, U.S. Pat. No. 7,830,785 disclosing a system and method for restoration in a multimedia IP network and US2009245248 describes a method and apparatus for providing resiliency in multicast networks.

Electronic packet switching technologies (e.g. IP/MPLS) require complex and intensive power consumption techniques (e.g. optoelectronic conversions, packet by packet processing, etc.) that present important inefficiency problems for high traffic volumes [14]. Therefore, electronic switching technologies consume much more power and network resources (i.e. ports, chassis, footprint, etc.) than optical switching technologies for high capacity traffic flows such as the ones generated by HDTV or UHDTV applications.

All above existing patent documents, both the ones regarding optical switching networks and the ones related to packet electronic switching networks, are exclusively focused on a given technology (i.e. electronic packet switching or optical switching), nor proposing to combine both kind of networks.

Such a combination is disclosed in U.S. Pat. No. 7,269,185, regarding a management and control of multilayer networks, and addressing multilayer coordination, including WSON and IP/MPLS network layers, even for distributing multicast services. However, said patent does not disclose, not even suggests, providing a multilayer restoration mechanism for multicast services, the several layers described not being arranged nor used for such a restoration purpose.

The present inventors don't know any proposal specifying any multilayer restoration mechanism for multicast services.

### DESCRIPTION OF THE INVENTION

It appears necessary to offer an alternative to the state of the art which covers the gaps found therein, particularly providing a solution to the problems referring to, on one hand, the slow recovery speed of optical networks and, on the other hand, the inefficiency problems for high traffic volumes of electronic switching networks.

To that end, the present invention provides, in a first aspect, a multilayer communications network for distributing multicast services, comprising at least a switched optical transport network layer, such as a Wavelength Switched Optical Network (WSON), and an electronic packet switched network layer, such as an Internet Protocol (IP) layer and/or a Multi Protocol Label Switching layer (MPLS), e.g. a IP/MPLS network layer.

On contrary to the proposal of U.S. Pat. No. 7,269,185, in the system of the first aspect of the invention, in a characteristic manner, the switched optical transport network layer transports multicast flows services and the electronic packet switched network layer is a backup layer of a dynamic restoration mechanism for recovery against one or more failures occurring in the switched optical transport network layer.

The switched optical transport network layer implements, for an embodiment, a network providing point to multipoint connections, or P2MP, said dynamic restoration mechanism being intended for the dynamic restoration of multiple failures in said point to multipoint connections.

According to an embodiment of the system of the first aspect of the invention, the switched optical transport network implements an optical multicast tree for distributing multicast flows there through, the multilayer communications network comprising a control plane module for computing a new multicast tree over the electronic packet switched network layer between a source node and destination nodes affected by a failure in the switched optical transport network, according to the available resources in the electronic packet switched network layer after the failure.

Other embodiments of the system of the first aspect of the invention are described in claims 6 to 13, and in a subsequent section.

A second aspect of the invention relates to a method for distributing multicast services through a multilayer communications network, where said multilayer communications network comprises at least a switched optical transport network layer and an electronic packet switched network layer.

On contrary to known proposals, the method of the second aspect of the invention comprises, in a characteristic manner, transporting multicast flows services through the switched optical transport network layer, and also comprises performing a recovery against one or more failures occurring in the switched optical transport network layer by means of a dynamic restoring carried out by using the electronic packet switched network layer as a backup layer.

For an embodiment, the method comprises:
implementing, in the switched optical transport network, an optical multicast tree for distributing multicast flows there through,
computing a new multicast tree over the electronic packet switched network layer between a source node and destination nodes affected by one or more failures in the switched optical transport network, according to the available resources in the electronic packet switched network layer after the failure or failures occurred; and
substituting at least the part of the optical multicast tree affected by the failure or failures with said new multicast tree.

According to an embodiment, the method comprises deleting the new multicast tree once the at least one failure has been repaired.

The method of the second aspect of the invention comprises, as per an embodiment, dynamically establishing over the electronic packet switched network layer the new multicast tree by means of multicast signalling.

For an embodiment of the method of the second aspect of the invention, and of a procedure of using the system of the first aspect, next actions are performed:
High capacity multicast flows (e.g. HDTV) services are transported by default over a WSON in order to minimize both power and network resources consumption.
In case of failure, a new control plane module, named MRM (Multilayer Restoration Manager), computes a new multicast tree over the electronic packet based network (e.g. IP/MPLS) between the source node (e.g. IPTV Head End) and the affected destination nodes (e.g. IP-TV Local Nodes), according to the available resources in this layer after the failure.
The new multicast tree computed by the MRM is dynamically established over the electronic layer (e.g. IP/MPLS) by means of multicast signalling [16].
Multicast flows (e.g. HD-TV channels) are distributed over both an optical multicast tree in the WSON and the new multicast tree over the electronic packet network (e.g. IP/MPLS) computed by the MRM. Destination nodes (e.g. Local IP-TV nodes) affected by the failure will receive the multicast flows (e.g. HDTV channels) over the electronic (e.g. IP/MPLS) network, while the rest of nodes will receive it from the original optical multicasting tree over WSON.
Once the failure is repaired, the MRM requests the electronic packet based (e.g. IP/MPLS) multicast tree deletion so that all destination nodes (e.g. IP-TV Local Nodes) would receive the multicast flows (e.g. HDTV channels) from the original optical multicasting tree over WSON.

The present invention thus relies on an innovative combination of multilayer and multicast restoration schemes in order to optimize power and network resources consumption and enhance survivability for high capacity multicast services, such as HDTV and UHDTV, providing a resilience scheme after a link cut.

The invention aims to solve the efficiency problems of packet electronic switching techniques in terms of power and network resources consumption by using optical multicasting over WSON as default transport technology for high capacity traffic flows such as HDTV or UHDTV. On the other hand, optical multicasting problems in terms of low recovery speed or survivability against multiple failures are solved by using dynamic restoration mechanisms at an electronic packet layer.

Therefore, the invention combines optical multicasting over, for example, WSON and dynamic P2MP restoration over electronic packet switching (e.g. IP/MPLS) in order to maximize multicast service availability while minimizing their related power and network resources consumption.

The proposed invention combines the advantages of electronic (e.g. IP/MLPS) and optical switching (e.g. WSON) in order to minimize the network costs while maximizing the service survivability. As the optical switching is used by default, power and network resources consumption are low. Electronic switching is exclusively used as back up layer in order to assure fast recovery against one or more failures in the optical layer. Moreover, the survivability against multiple failures is high despite using the optical switching by default, because the service restoration after one or multiple failures is performed over a back up electronic packet switching network.

### BRIEF DESCRIPTION OF THE DRAWINGS

The previous and other advantages and features will be more fully understood from the following detailed description of embodiments, with reference to the attached drawings (some of which have already been described in the Prior State of the Art section), which must be considered in an illustrative and non-limiting manner, in which:

FIG. 1 shows an example of IP-TV distribution over WSON.

FIG. 2 shows pre-calculated working (a) and backup (b) multicast trees for the 1+1 protection mechanism.

FIG. 3 shows a generic IP hierarchical network architecture.

FIG. 4 shows the modules of the system of the invention for an embodiment.

FIG. 5 shows the architecture of the transmission module architecture depicted in FIG. 4, where modules 3.2.1 and 3.2.2 are based on existing technologies.

FIG. 6 shows the architecture of the reception module illustrated in FIG. 4, where modules 3.3.1, 3.3.2 and 3.3.3 are based on existing technologies and Cr and Ci interfaces are innovative elements of this module.

FIG. 7 shows the multicast restoration manager illustrated in FIG. 4.

FIG. 8 shows a high level IP-TV architecture and invention's scope, for an embodiment.

FIG. 9 shows part of the system of the invention for an embodiment where it comprises IP/MLPS over WSON.

FIG. 10 shows part of the system of the invention for HDTV distribution over WSON, including an IP/MPLS network being unused before a failure occurs.

FIG. 11 shows the same elements of FIG. 11, but after a failure in the WSON network has occurred, the IP/MPLS implementing backup connections for the traffic interrupted by said failure.

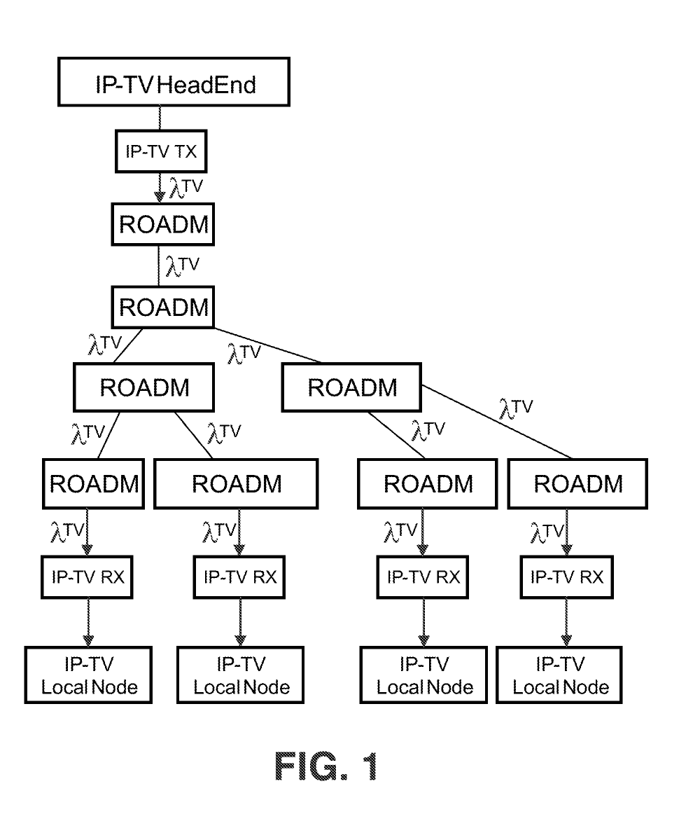

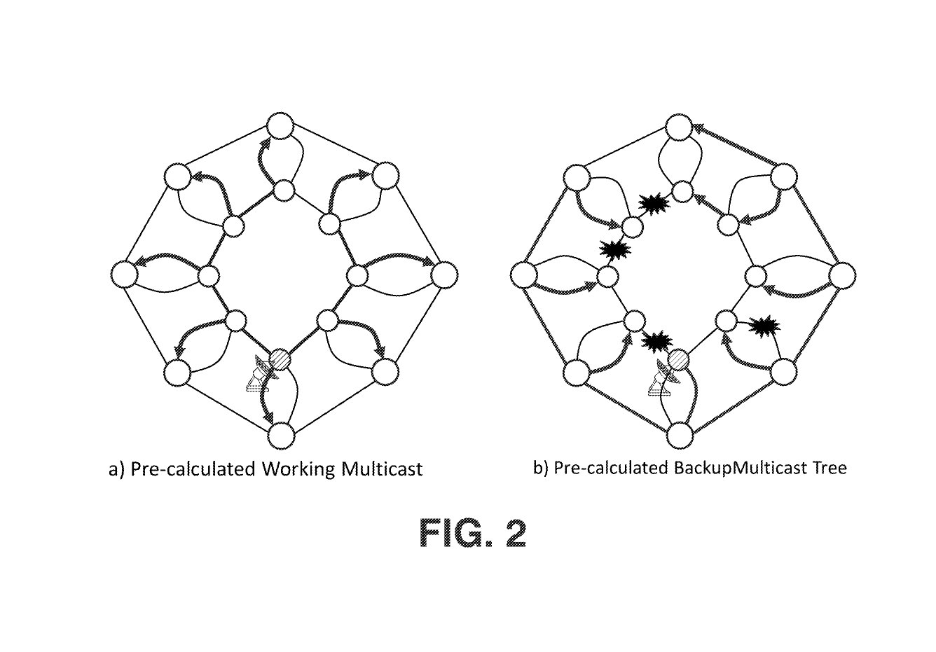

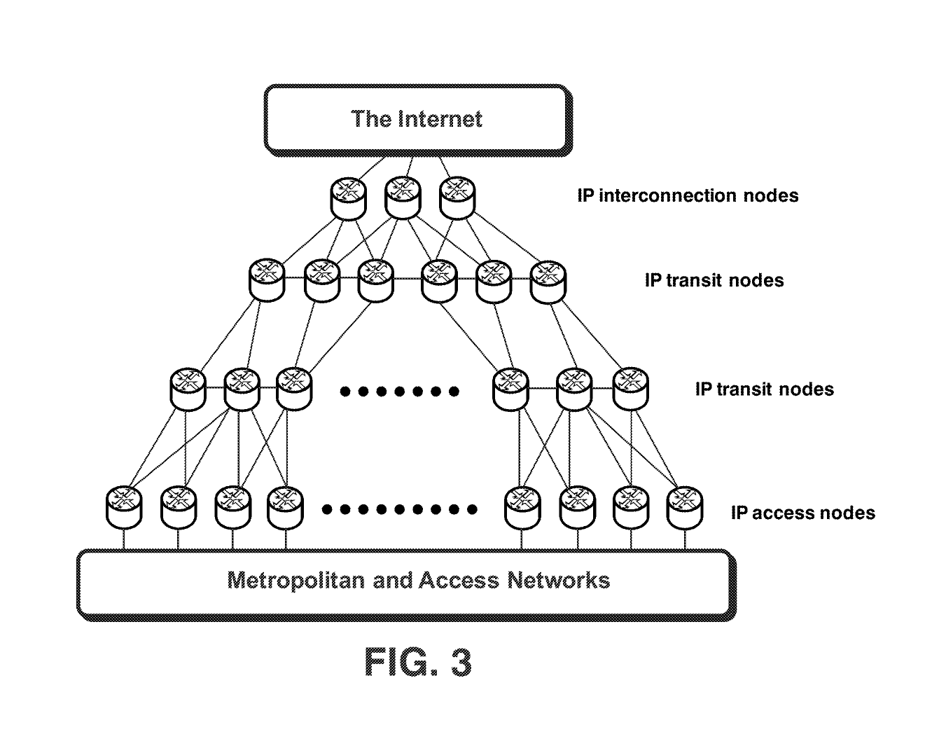

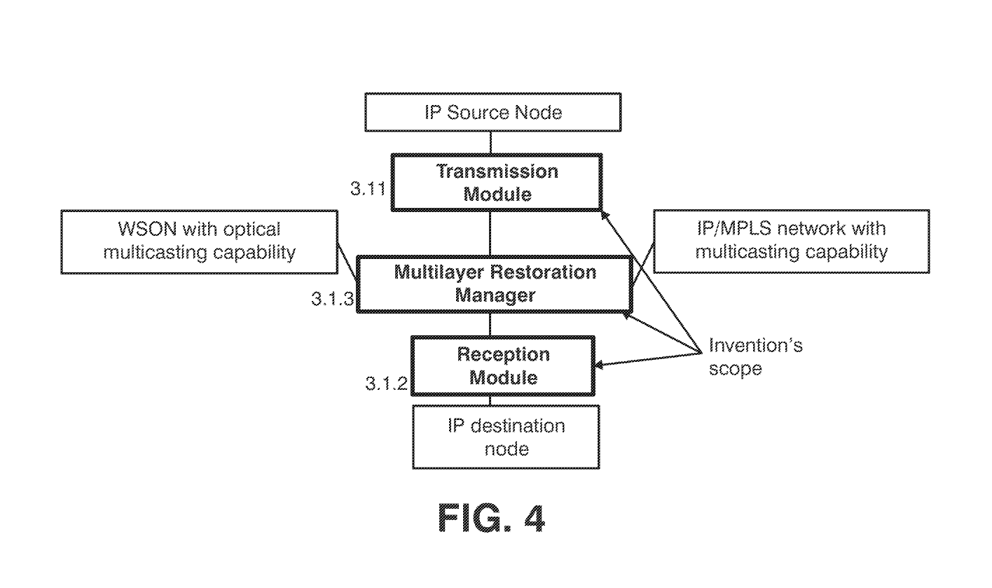

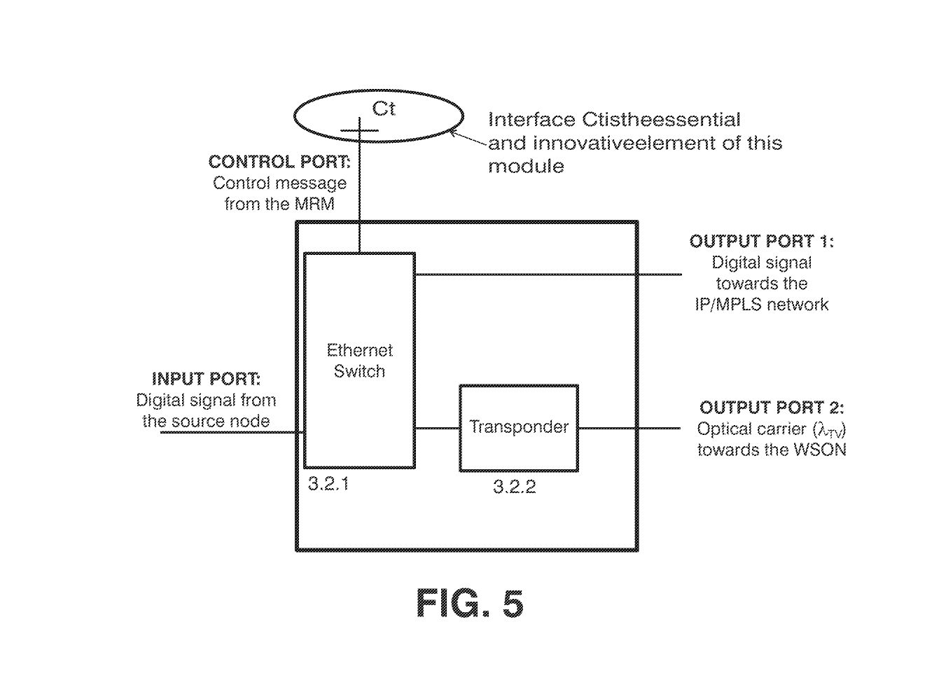

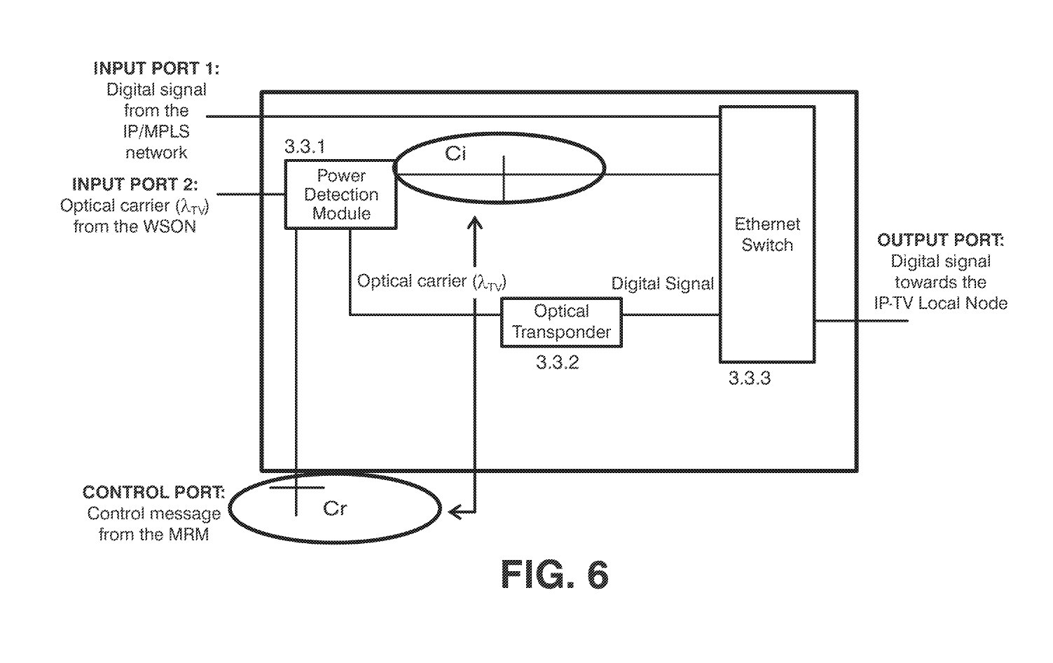

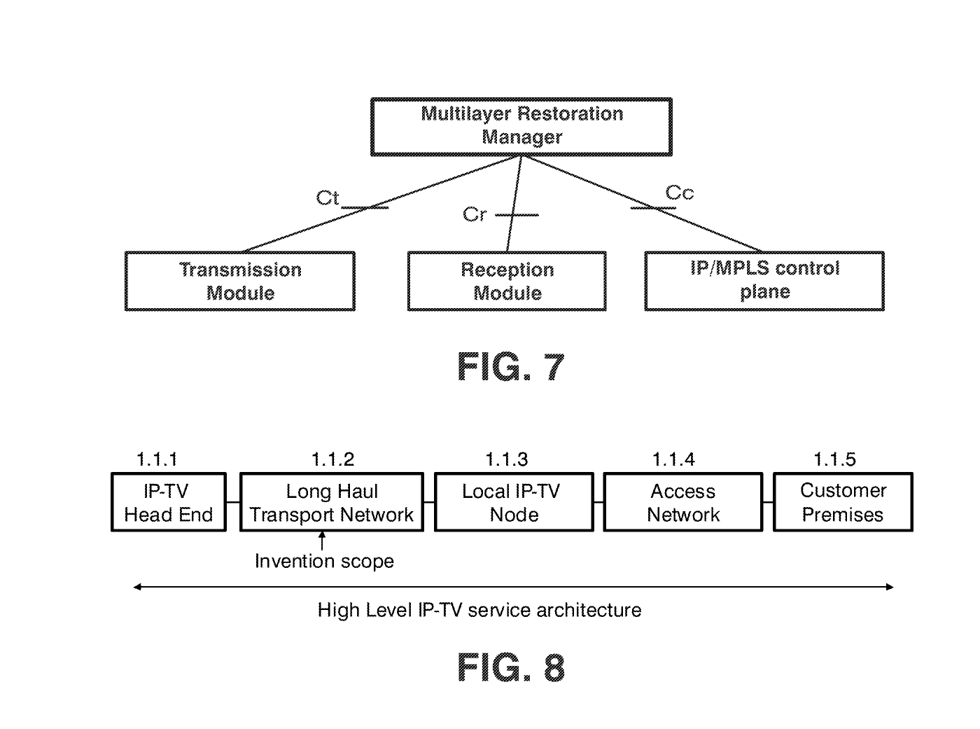

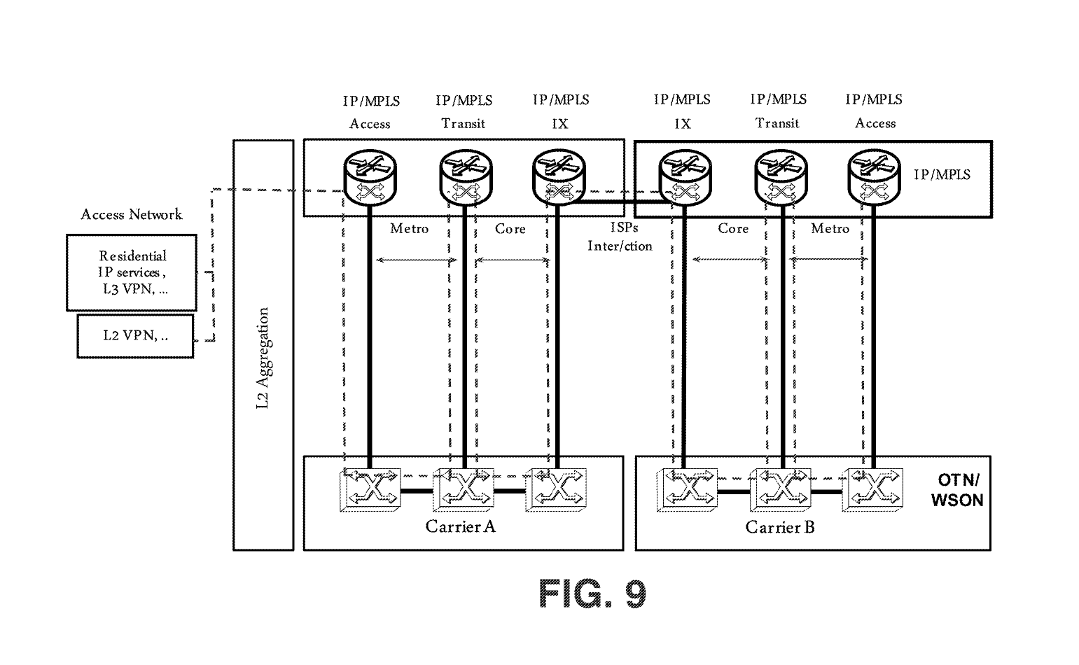

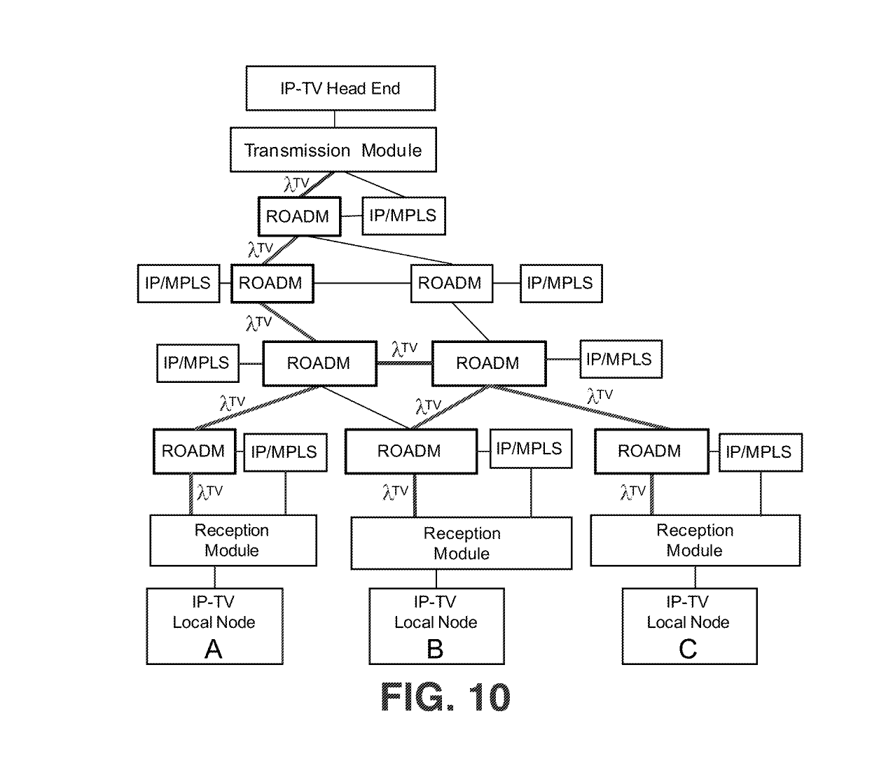

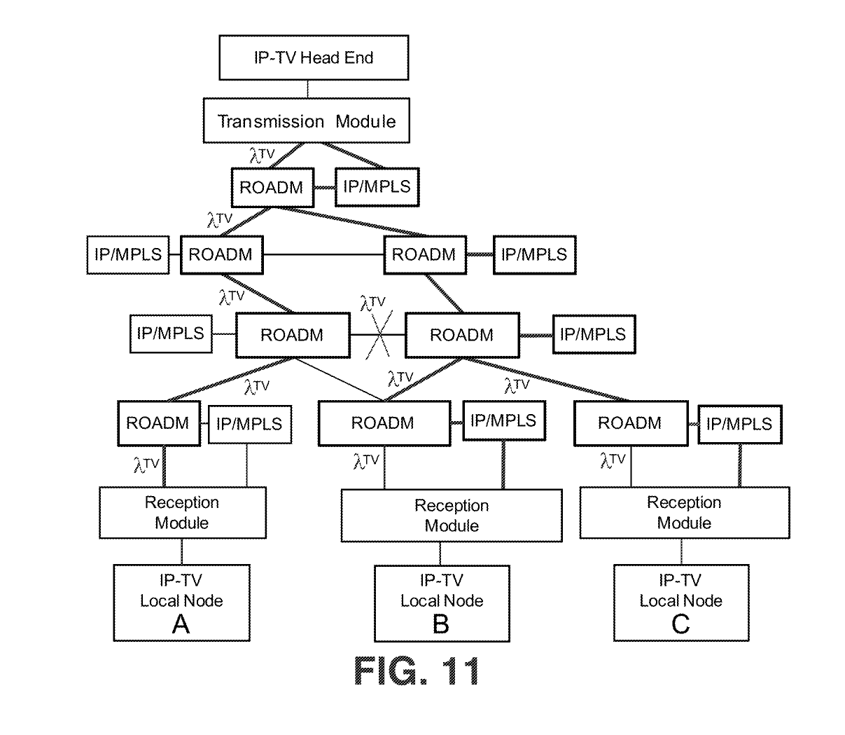

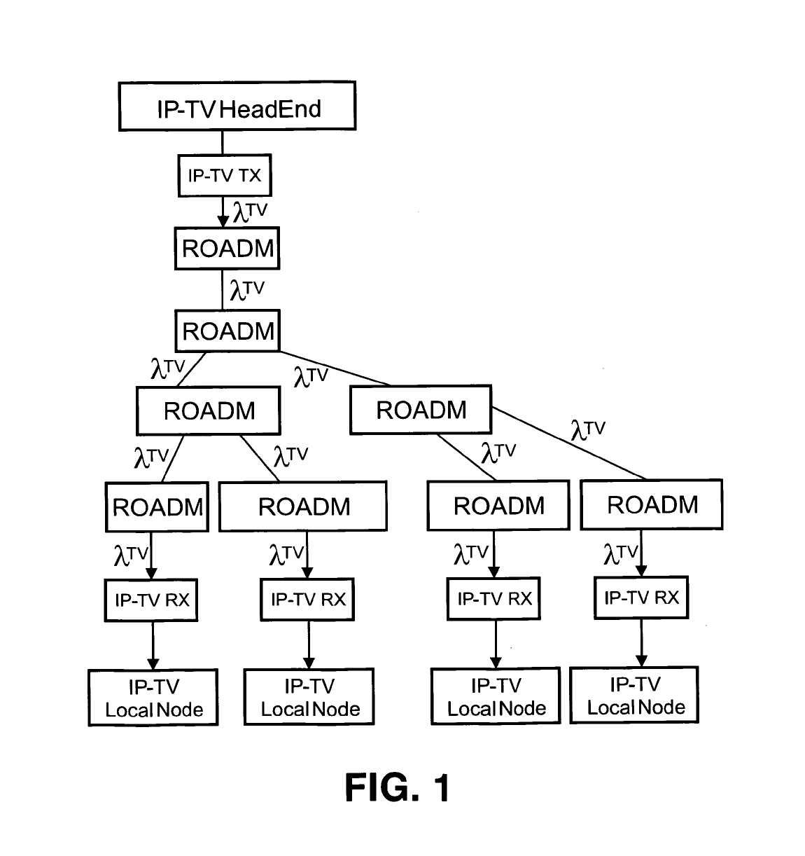

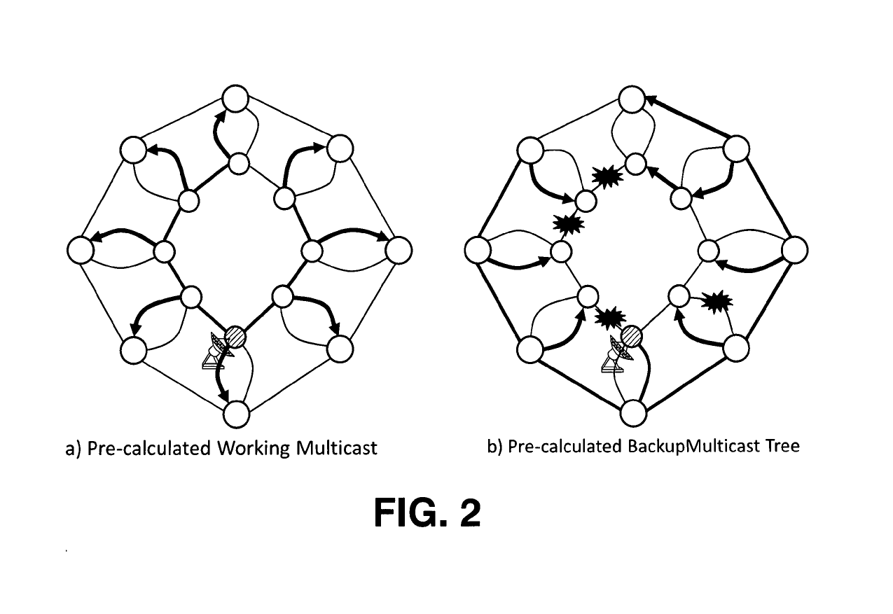

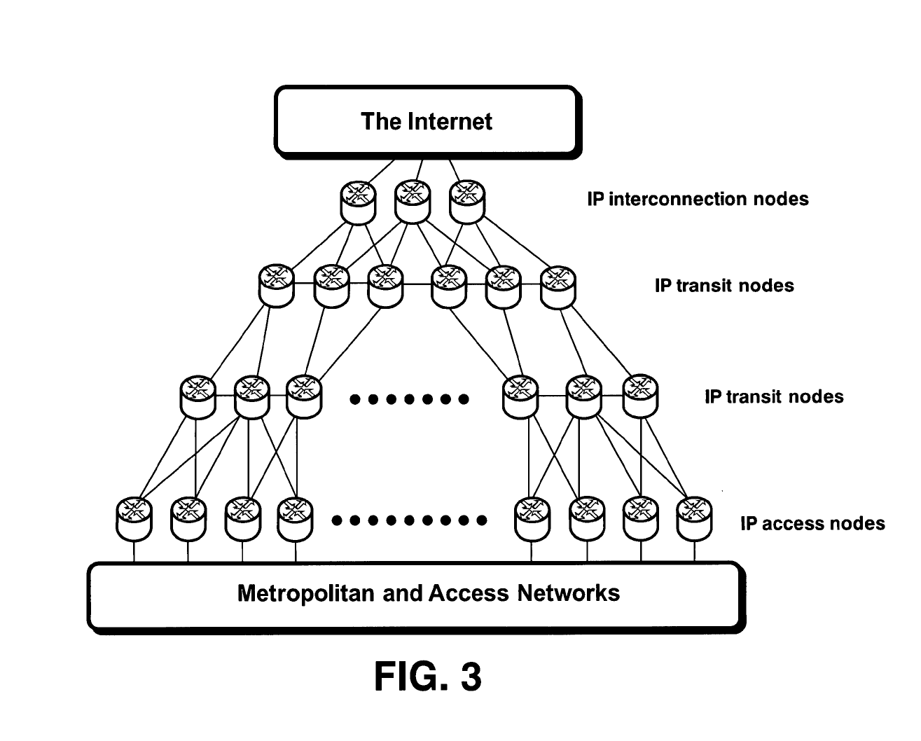

### DETAILED DESCRIPTION OF SEVERAL EMBODIMENTS

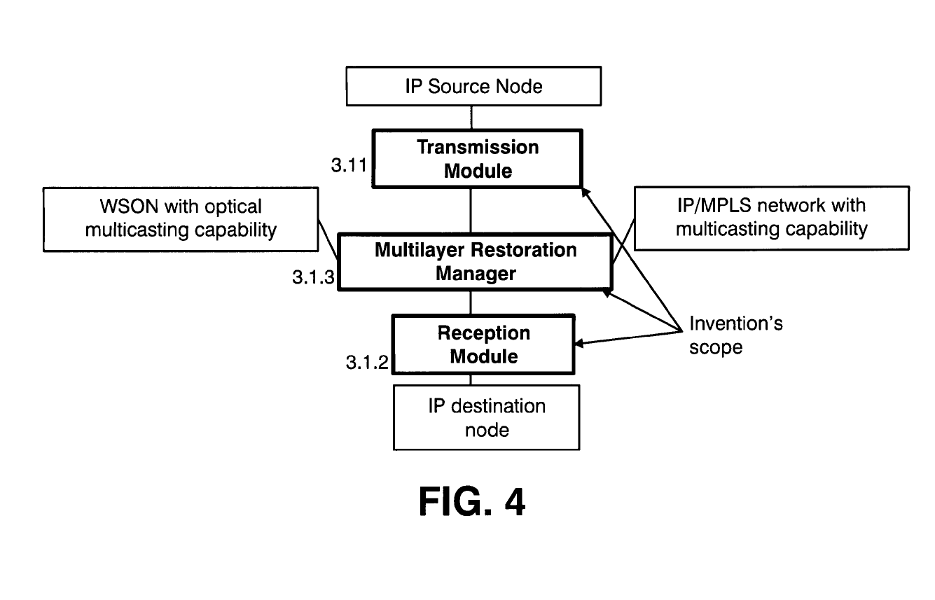

As it is shown in FIG. 4, the system of the first aspect of invention comprises, for the illustrated embodiment, three modules: a transmission module to be installed in source node (e.g. IP TV Head End), a reception module to be installed in Metropolitan Points of Presence and a Multilayer Restoration Module (MRM) to be connected to both WSON and IP/MPLS networks.

The transmission module receives digital signal from the source node (e.g IP-TV Head End) by the INPUT PORT and either distributes it by the OUTPUT PORT1 towards an IP/MPLS router or by the OUTPUT PORT2 towards a WSON node, according to the information received from the CONTROL PORT. The optical signal distributed by OUTPOUT PORT2 is sent to a WSON node.

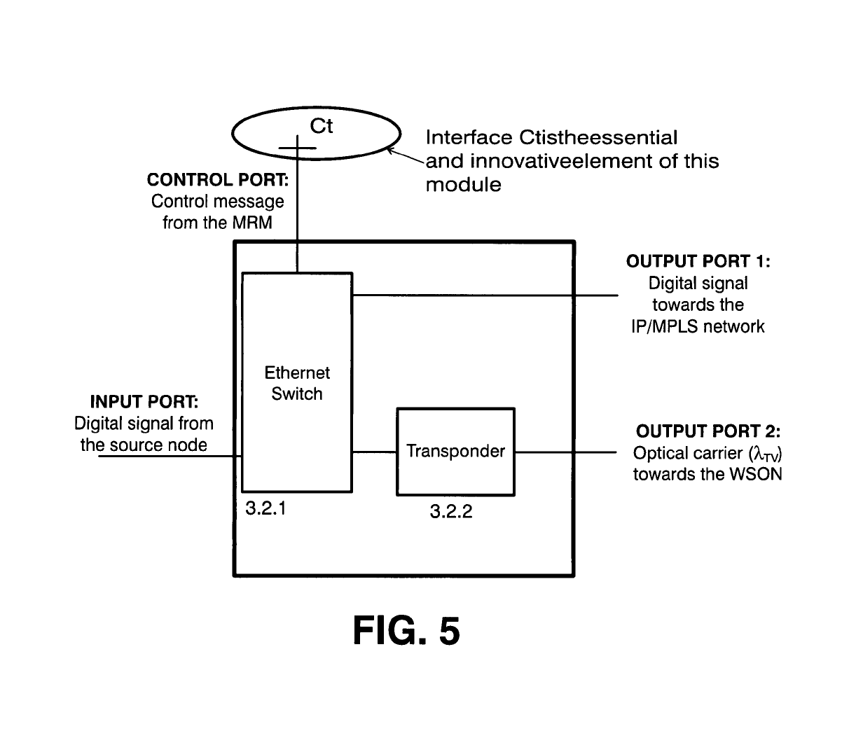

As highlighted in FIG. 5, interface Ct, which is the interface between Transmission Module and Multilayer Restoration Module (MRM), is the essential and innovative element of this module. This interface allows the MRM to activate or deactivate OUTPUT PORT1 so that the multicast traffic (e.g HD-TV) is distributed over both: OUTPUT PORT1 and OUTPUT PORT2 or only over OU TPORT2.

In particular the Ct messages are received over the CONTROL PORT are the following:
IP_P2MP_request: This request is sent by the MRM to the transmission module in order to activate OUTPUT PORT2 so that the digital signal received from the source node is sent towards an IP/MPLS node.
IP_P2MP_remove: This message is sent by the MRM in order to deactivate OUPUT PORT 1 so that the multicast signal is exclusively distributed over OUTPUT PORT2.

This interface Ct allows the MRM to dynamically select the appropriate distribution layer for a multicast flow.

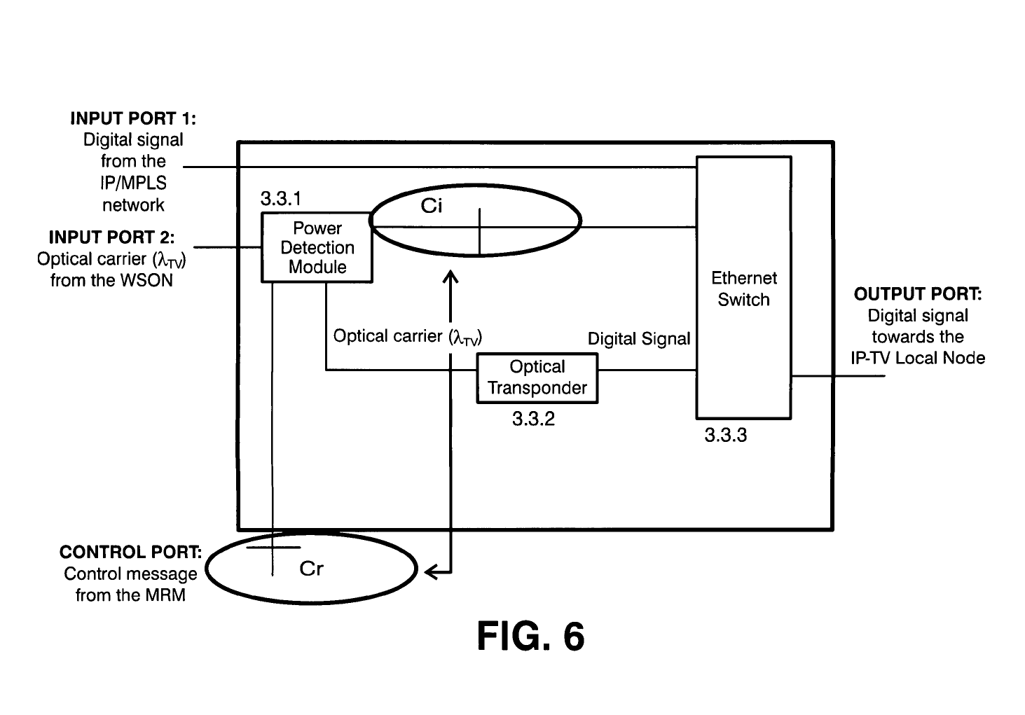

As shown in FIG. 6, the reception module provides a multicast HD-TV digital signal (e.g HD-TV) to be sent towards an IP-TV local Node over OUTPOUT PORT according to the signals received over INPUT PORT1 from the IP/MPLS network or over INPUT PORT2 from the WSON. In case o failure in the WSON network, the Power Detection Module detects a Loss of Signal and sends a control messages over the Cr and Ci interfaces.

Cr is the interface between the Transmission Module and the Multilayer Restoration Module (MRM). This interface allows the Reception Module to inform the MRM about Loss of Signal and Signal Recovery in the WSON. The following messages are sent over this interface:
LOS_notification: This message is sent by the Reception Module to the MRM in order to inform about a failure in the WSON.
SR_notification: This message is sent by the Reception Module in order to inform about a service recovery in the WSON.

Ci is the internal interface between the Power Detection Module and the Ethernet Switch. This interface allows the Power Detection Module to activate or deactivate the Ethernet switch input port connected to the optical transponder. The following messages are sent over this interface:
Optical port activation: This message is sent by the Power detection Module after a Loss of Signal detection in order to deactivate the Ethernet switch input port connected to the optical transponder
Optical port deactivation: This message is sent by the Power Detection Module after an optical signal recovery in order to activate the Ethernet switch input port connected to the optical transponder.

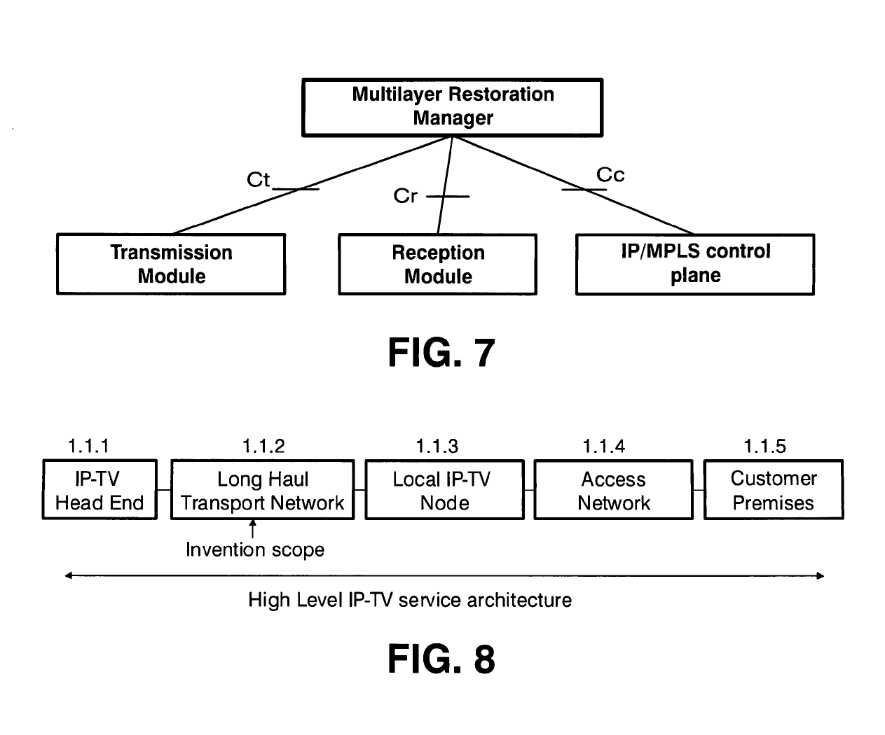

The Multilayer Restoration Manager (FIG. 7) is the module in charge of triggering a new multicast tree over the IP/MPLS network after a failure in the WSON and deleting it after the failure recovery.

Next, two procedures are described referring to both, embodiments of the method of the second aspect of the invention, and also as describing the actions to perform, for some embodiments, by the different elements of the system of the first aspect of the invention.

Procedure after a Failure in the WSON:

The information distributed over the Cr interface (SR_notification) allows the MRM to be informed about the Local Nodes being affected by a failure in the WSON.

After receiving the failure notification, the MRM request IP/MPLS network status information over the Cc interface between the MRM and the management/monitoring system of the IP/MPLS network. This interface allows the MRM to receive IP/MPLS network status information and send multicast connections request. The following messages are exchanged over this interface:
IPMPLS_status request: this request is sent by MRM to the IP/MPLS network monitoring/fault management system in order to get information about the available resources in the IP/MPLS network. This request is done after receiving a LOS_notification message from one or more Reception Modules.
IPMPLS_status response: this is the response sent by the IP/MPLS monitoring/management system to the MRM in order to provide information about the available IP/MPLS network resources. This information is used by the MRM in order to compute the optimum multicast tree over the IP/MPLS network between the IP-TV Head End and those IP-TV Local Nodes affected by a failure in the WSON.

Once the optimum multicast tree is computed the MRM could trigger the multicast tree set up by exchanging the following messages over the Cs interface between the MRM and the IP/MPLS nodes.
P2MP_Setup_request: this request is sent by the MRM to request for the configuration of a new P2MP link the Transmission and the Reception Modules affected by the failure in the WSON. It includes the control IP addresses of the IP-TV Head End and Local nodes that should be linked through the new P2MP connection. It also includes the bandwidth that should be located to the new tree (e.g 6 Gbps) through this path. This message is sent by the MRM after computing the optimum path.
P2MP_Setup_response: it provides the information about the result of the new P2MP link configuration.

Once the IP/MPLS multicast tree is available the MRM sends an IP_P2MP_request to the Transmission Module over the Ct interface in order to send the HD-TV traffic over the IP/MPLS network. This message is sent after receiving a P2MP_Setup_response message from the Cs interface.

Procedure after a Service Recovery in the WSON

The information distributed over the Cr interface (SR_notification) allows the MRM to be informed about the service recovery in the WSON.

After receiving the failure notification, the MRM request the IP/MPLS multicast connection tear down by exchanging the following messages over the CS interface:
Remove_P2MP_request: this request is used to remove a P2MP connection over the IP/MPLS network. It includes the information about the IP control addresses of the nodes affected and the bandwidth that must be removed. This message is sent by the MRM after receiving a SR_notification from one or more Reception Modules.
Remove_P2MP_response: it provides the information about the result of the link removal.

Once the IP/MPLS multicast tree is removed the MRM sends an IP_P2MP_remove message to the Transmission Module over the Ct interface in order to remove the multicast traffic from the IP/MPLS network. This message is sent after receiving a Remove_P2MP_response message from the Cs interface.

A potential use case of the proposed invention could be IPTV distribution and restoration in IP/MLPS over WSON core networks. IP-TV is digital television delivered through high speed internet connection. In this service, channels are encoded in IP format and delivered to the TV through an operator's transport network. As shown in FIG. 8, the use case is related to long haul IP-TV transport from a centralized (e.g national) Head End to multiple metropolitan Points of Presence (PoPs).

IP-TV traffic volume over long haul networks does not depend on the number of customers but on the number, definition and codification of TV channels. A potential service including 100 HDTV channels, 10 3D TV channels and 10 UHDTV channels would need 6 Gbps from the TV Head-End to the rest of Service PoPs in the metro area.

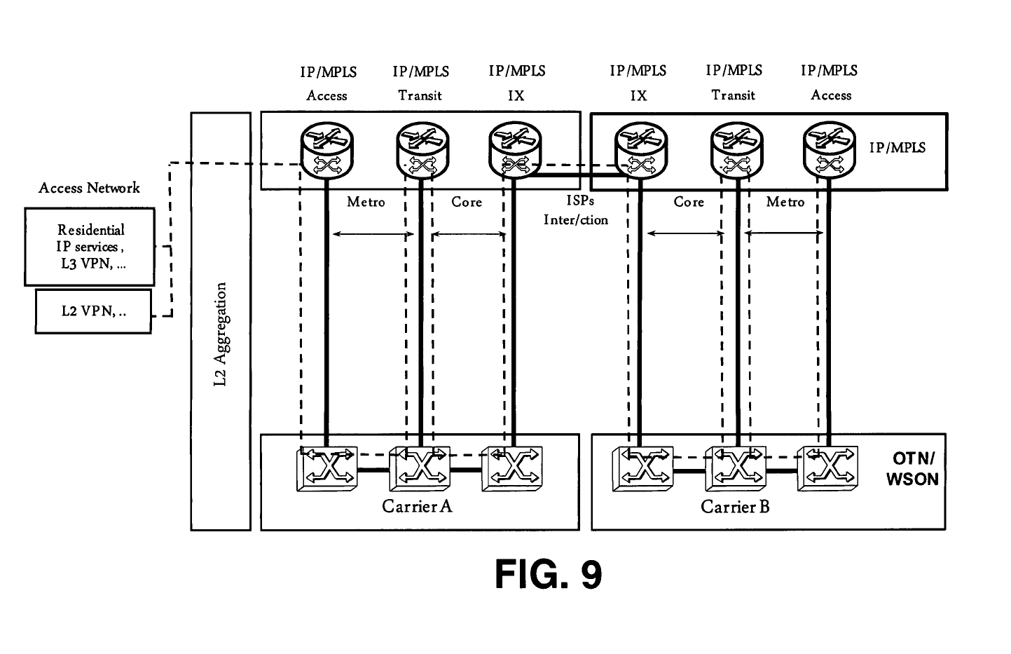

The proposed invention could be applied in Long-Haul Transport Networks FIG. 9 based on an overlay combination of two different technologies: IP/MPLS and WSON. The rationale behind this combination of technologies is described in [14]. In particular, the invention's scope is related to the dynamic restoration of multiple failures (e.g link cuts) in point to multipoint connections as the ones required for IP-TV distribution.

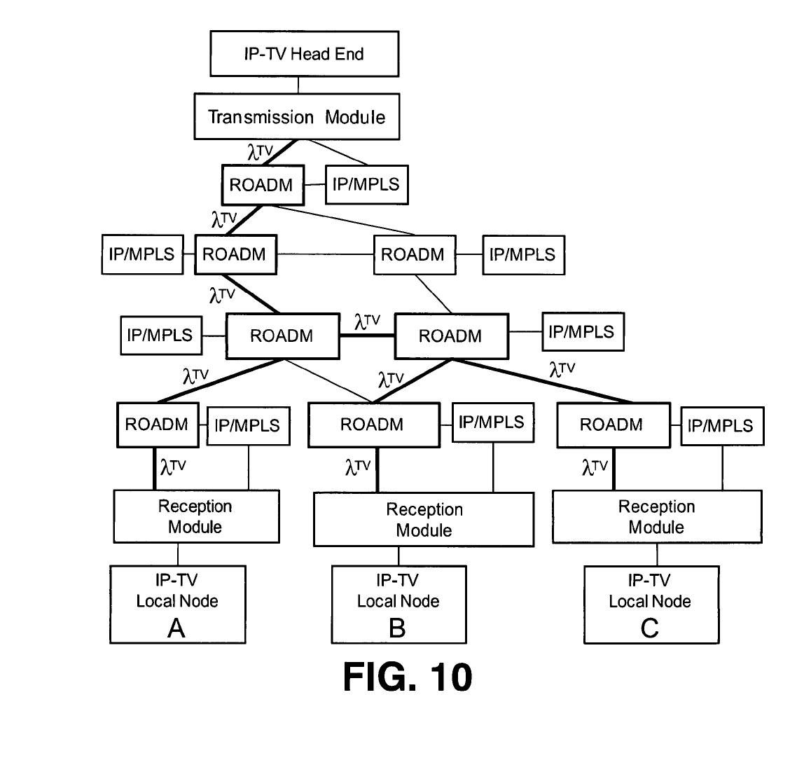

A digital IP-TV stream at 6 Gbps including all TV channels is sent over an optical carrier (λTV) by the transmission module. This optical carrier is optically distributed by the WSON up to all destination nodes where the reception module converts the optical signals into the original IP-TV stream generated by the Head End. As shown in FIG. 10, HDTV service from the IP-TV Head End towards three IP-TV Local Nodes (A, B and C) is distributed over an optical multicasting tree (highlighted in grey) by default.

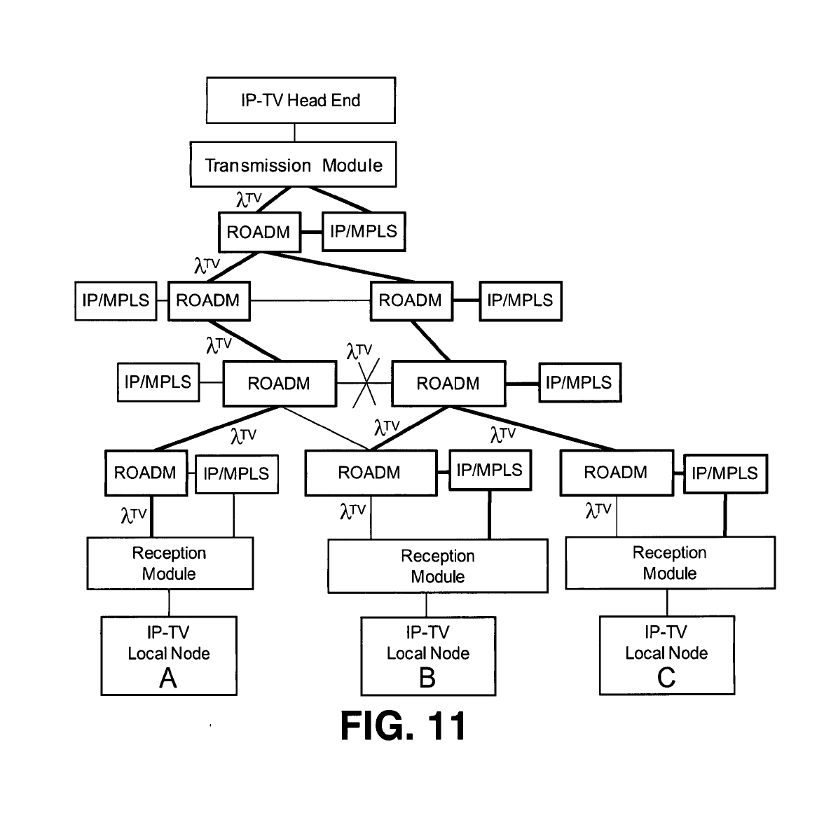

In FIG. 11 the new configuration after a failure in the WSON can be seen (also highlighted in grey). According to the procedure described, after a failure the P2MP connection between the IP-TV Head End and the affected Local Nodes (B and C) is restored over the IP/MPLS network while the rest of nodes (e.g A) are still receiving this service over the WSON. Once the failure is repaired, the network will come back to the configuration by default shown FIG. 10.

A person skilled in the art could introduce changes and modifications in the embodiments described without departing from the scope of the invention as it is defined in the attached claims.

### Acronyms and Abbreviations

ASE AMPLIFIED SPONTANEOUS EMISSIONS

CSNRZ CARRIER-SUPPRESSED NON RETURN-TO-ZERO (CSNRZ)

DPSK DIFFERENTIAL PHASE SHIFT KEYING

IP INTERNET PROTOCOL

IPTV INTERNET PROTOCOL TELEVISION (IP-TV)

MPLS MULTI PROTOCOL LABEL SWITCHING

OSNR OPTICAL SIGNAL TO NOISE RATIO

ROADM RECONFIGURABLE OPTICAL ADD DROP MULTIPLEXER

UHDTV ULTRA HIGH DEFINITION TV

WSON WAVELENGTH SWITCHED OPTICAL NETWORKS

### REFERENCES

[1] IETF Fast Reroute standard. http://www.ietf.org/rfc/rfc4090.txt
[2] IETF P2MP MPLS Standard http://tools.ietf.org/html/rfc4687
[3] RPR: standards http://grouper.ieee.org/groups/802/17/
[4] PBB-TE standards http://www.ieee802.org/1/pages/802.1aq.html
[5] OTN standards http://www.itu.int/rec/T-REC-G.709/e
[6] WSON definition: draft-ietf-ccamp-wavelength-switched-framework (http://tools.ietf.org/html/draft-ietf-ccamp-rwa-wson-framework-03)
[7] IP over Optical Multicasting for Large-Scale Video Delivery. http://front.sjtu.edu.cn/download.php?pid=354
[8] E. Salvadori, Y. Ye, A. Zanardi, H. Woesnet, M. Carcagni, G. Galimberti, G. Martinelli, A. Tanzi, and D. La Fauci, “A study of connection management approaches for an impairment-aware optical control plane”, Lecture Notes in Computer Science, pp. 229-238, 2007. DOI 10.1007/978-3-540-72731-6.
[9] ITU-T.G.680.
[10] D. van den Borne, “Robust optical transmission systems: modulation and equalization”, Ph.D. thesis, Eindhoven University of Technology, 2008. Available online: Eindhoven University Library.
[11] ITU-T G.694.
[12] A Novel Optical Modulation Format CSNRZ. Zhang Dechao Li Zhengbin Chen Zhangyuan Li Hongbin Xu Anshi Nat. Lab. on Local Fibre-Optic Commun. Networks, Peking Univ., Beijing.
[13] A Differential Phase Shift Keying (DPSK) modulator for a frequency hopping short wave system. Eriksson, Mats; Eriksson, Gunnar.
[14] Migration Steps Towards the STRONGEST Architecture. Juan Fernandez-Palacios et al. NOC 2010 Conference. Faro (Portugal) 8 Jun. 2010.
[15] IETF RFC 3031, “Multiprotocol Label Switching Architecture”.
[16] Link Failure Recovery for MPLS Networks with Multicasting. A Thesis Presented to the faculty of the School of Engineering and Applied Science. University of Virginia.

1-16. (canceled)

17. A multilayer communications network system for distributing multicast services, comprising at least a switched optical transport network layer and an electronic packet switched network layer, said switched optical transport network layer transports multicast flows services and said electronic packet switched network layer is a backup layer of a dynamic restoration mechanism for recovery against one or more failures occurring in the switched optical transport network layer wherein said switched optical transport network implements an optical multicast tree for distributing multicast flows there through, the multilayer communications network system comprising a control plane module for computing a new multicast tree over the electronic packet switched network layer between a source node and destination nodes affected by a failure in the switched optical transport network, according to the available resources in the electronic packet switched network layer after the failure.

18. A multilayer communications network system as per claim 17, wherein said switched optical transport network layer is a Wavelength Switched Optical Network, or WSON.

19. A multilayer communications network system as per claim 17, wherein said electronic packet switched network layer is an Internet Protocol, or IP, layer and/or a Multi Protocol Label Switching layer, or MPLS.

20. A multilayer communications network system as per claim 17, wherein said switched optical transport network layer implements a network providing point to multipoint connections, or P2MP, said dynamic restoration mechanism being intended for the dynamic restoration of multiple failures in said point to multipoint connections.

21. A multilayer communications network system as per claim 17, comprising:
at least one transmission module (3.1.1) with an input connected to said source node for receiving digital signals, first and second outputs connected, respectively, to the switched optical transport network and the electronic packet switched network, and with a control interface (Ct) for receiving control orders to dynamically select through which of said first and second outputs to send the received digital signals;
at least one reception module (3.1.2) to be installed in a metropolitan point of presence for receiving said digital signals; and
a multilayer restoration manager module (3.1.3), implementing said control plane module, to be connected to both the switched optical transport network and the electronic packet switched network, and to said control interface (Ct) of said at least one transmission module (3.1.1) for sending to the control interface (Ct) said control orders.

22. A multilayer communications network system as per claim 21, wherein said at least one reception module (3.1.2) comprises:
first and second inputs connected, respectively, to the switched optical transport network and the electronic packet switched network, for receiving said digital signals from at least one of the two networks;
a power detection module (3.3.1) connected to said first input for detecting a loss of signal, indicative of a failure in the switched optical transport network, and for sending a loss of signal control message;
a network switch (3.3.3) with two inputs respectively connected to said second input, directly, and to said first input, through an optical transponder (3.3.2), an output for providing the digital signals received through at least one of said first and second inputs, and a control input;
a restoration interface (Cr) connected to said power detection module (3.3.1) for receiving said loss of signal control message, and connected with the multilayer restoration manager module (3.1.3) for sending to the latter said loss of signal control message and a service recovery message, when digital signal is received again through said first input; and
an internal interface (Ci) connecting the power detection module (3.3.1) with said control input of said network switch (3.3.3), for allowing the power detection module (3.3.1) to activate or deactivate said input connected to said optical transponder (3.3.2), by sending the power detection module (3.3.1), over said internal interface (Ci), an optical port deactivation message, after a loss of signal detection, to perform said deactivation, and an optical port activation message, after an optical signal recovery, to perform said activation.

23. A multilayer communications network system as per claim 22, wherein multilayer restoration manager module (3.1.3) is also in charge of computing and setting up of said new multicast tree over the electronic packet switched network after a failure in the switched optical transport network, detected upon the reception of at least said loss of signal control message through said restoration interface (Cr), and of deleting it after the failure recovery, detected upon the reception of said service recovery message.

24. A multilayer communications network system as per claim 23, wherein multilayer restoration manager module (3.1.3) is connected, through an interface (Cc), to a management/monitoring system of the electronic packet switched network for:
requesting, the multilayer restoration manager module (3.1.3), after the reception of the loss of signal control message, electronic packet switched network status information regarding its available resources; and
receiving a response to said request, from the electronic packet switched network, including said requested information regarding its available resources, said multilayer restoration manager module (3.1.3) using said information for computing the new multicast tree, as the optimum one according to the available resources.

25. A multilayer communications network system as per claim 24, wherein the multilayer restoration manager module (3.1.3) is connected, through an interface (Cs), to the electronic packet switched network for triggering the setting up of the computed new multicast tree by exchanging the following messages over said interface (Cs):
a setup request message, sent by the multilayer restoration manager module (3.1.3), for the configuration of at least one new P2MP path for linking the transmission modules (3.1.1) and the reception modules (3.1.2) affected by the failure in the switched optical transport network, said setup request message including data for building said at least one P2MP path; and
a setup response message, sent by the electronic packet switched network, providing information about the result of the new P2MP path configuration.

26. A multilayer communications network system as per claim 25, wherein the multilayer restoration manager module (3.1.3) is intended for, once the new multicast tree is built, sending said control orders to said at least one transmission module (3.1.1) through said control interface (Ct), in order to dynamically select said second output through which sending the received digital signals.

27. A multilayer communications network system as per claim 24, wherein the multilayer restoration manager module (3.1.3) is intended for, after the reception of said service recovery message through said restoration interface (Cr), requesting the electronic packet switched network to tear down said at least one new P2PM path, by exchanging the following messages over said interface (Cs) connecting them:
a remove request message, sent by the multilayer restoration manager module (3.1.3), for the removing of said at least one new P2MP path, said remove request message including data allowing aid removing; and
a remove response message, sent by the electronic packet switched network, providing information about the result of the new P2MP path removal.

28. A multilayer communications network system as per claim 27, wherein the multilayer restoration manager module (3.1.3) is intended for, once the new multicast tree is removed, sending said control orders to said at least one transmission module (3.1.1) through said control interface (Ct), in order to dynamically at least unselect said second output to avoid the digital signals to circulate through the electronic packet switched network.

29. A method for distributing multicast services through a multilayer communications network system, where said multilayer communications network system comprises at least a switched optical transport network layer and an electronic packet switched network layer, comprises transporting multicast flows services through said switched optical transport network layer, and it comprises performing a recovery against one or more failures occurring in the switched optical transport network layer by means of a dynamic restoring carried out by using said electronic packet switched network layer as a backup layer, the method further comprises:
implementing, in said switched optical transport network, an optical multicast tree for distributing multicast flows there through,
computing a new multicast tree over the electronic packet switched network layer between a source node and destination nodes affected by at least one failure in the switched optical transport network, according to the available resources in the electronic packet switched network layer after the failure; and
substituting at least the part of said optical multicast tree affected by said at least one failure with said new multicast tree.

30. A method as per claim 29, comprising deleting the new multicast tree once the at least one failure has been repaired.

31. A method as per claim 29, comprising dynamically establishing over the electronic packet switched network layer the new multicast tree by means of multicast signaling.

32. A method as per claim 29, comprising using a multilayer communications network system to carry out the different actions of the method, the multilayer communications network system comprising at least a switched optical transport network layer and an electronic packet switched network layer, said switched optical transport network layer transports multicast flows services and said electronic packet switched network layer is a backup layer of a dynamic restoration mechanism for recovery against one or more failures occurring in the switched optical transport network layer wherein said switched optical transport network implements an optical multicast tree for distributing multicast flows there through, the multilayer communications network system comprising a control plane module for computing a new multicast tree over the electronic packet switched network layer between a source node and destination nodes affected by a failure in the switched optical transport network, according to the available resources in the electronic packet switched network layer after the failure.
